(19) United States
(12) Patent Application Publication
(10) Pub. No.: US 2023/0066770 A1
(43) Pub. Date: Mar. 2, 2023

(54) CROSS-CHANNEL ACTIONABLE INSIGHTS

(71) Applicant: Upswot, Inc., Wilmington, DE (US)

(72) Inventors: Pavlo Martinovych, Kyiv (UA); Roman Ukrainets, Kyiv (UA); Serhii Natochii, Kyiv (UA); Anastasiia Dziuba, Kyiv (UA); Dmytro Norenko, Charlotte, NC (US); Dmytro Syvolap, Kyiv (UA); Serhii Hladchenko, Kyiv (UA); Oksana Abdurazakova, Kyiv (UA); Andrii Davydchuk, Kyiv (UA); Tatiana Gorgadze, Tbilisi (GE)

(21) Appl. No.: 17/563,544

(22) Filed: Dec. 28, 2021

Related U.S. Application Data
(60) Provisional application No. 63/237,737, filed on Aug. 27, 2021.

(51) Int. Cl. G06Q 10/06; G06F 16/22; G06F 16/25; G06N 5/04

(52) U.S. Cl. CPC G06Q 10/06375; G06F 16/221; G06F 16/258; G06N 5/04

(57) ABSTRACT

The disclosed computer-implemented method may include accessing data from multiple different data sources, where each data source is associated with a common objective. The method may next include restructuring the accessed data from the various different data sources into a unified format. Still further, the method may include identifying dependencies between the accessed data from the different data sources, and then analyzing the accessed data and the identified dependencies to determine at least one operational step that is to be taken to further the common objective. The method may also include implementing the determined operational step. Various other methods, systems, and computer-readable media are also disclosed.

### CROSS-REFERENCE TO RELATED APPLICATIONS

This application claims priority to and the benefit of U.S. Provisional Patent Application No. 63/237,737, filed Aug. 27, 2021, which application is incorporated by reference herein in its entirety.

### BACKGROUND

Entities, including individuals, businesses, or governments, often desire to improve various operations. These operations may result in the production of a physical product, or the provisioning of a software application, or providing a background database to serve data to users all over the world. Regardless of the operation or type of operation, each entity may seek to improve how their tasks are carried out. In some cases, however, entities may be unaware of which steps to take to improve their operations. Some may tend to focus on a single recommendation from a single source, or may receive disparate and unintelligible information from many different sources, and may never realize the improvements they were hoping to see.

### BRIEF SUMMARY

As will be described in greater detail below, the present disclosure generally describes methods and systems for providing actionable, operational steps to entities based on input data from a variety of data sources.

In one embodiment, a computer-implemented method may be provided. The method may include accessing data from multiple different data sources, where each data source is associated with a common objective. The method may further include restructuring the accessed data from the different data sources into a unified format. The method may also include identifying dependencies between the accessed data from the different data sources and analyzing the accessed data and the identified dependencies to determine at least one operational step that is to be taken to further the common objective. Still further, the method may include notifying one or more entities of the determined operational step and then implementing the determined operational step.

In some cases, the determined operational step may include changing one or more operational parameters on a software application. In some embodiments, the determined operational step may include changing one or more operational parameters of a computer hardware component.

In some examples, the step of accessing data from the different data sources may be automatically performed on a specified periodic basis. In some cases, the method may further include calculating one or more common objective indicators based on the accessed data from the different sources, and comparing the calculated common objective indicators when analyzing the identified dependencies to determine the at least one operational step that is to be taken.

In some cases, the method may further include predicting, based on various factors, at least one outcome of the determined operational step. In some examples, analyzing the accessed data and the identified dependencies to determine an operational step that is to be taken may include performing an analysis to ensure that the operational step is actionable.

In some embodiments, the plurality of different data sources may include accountancy data, client relationship management (CRM) data, eCommerce data, web analytics data, logistics data, point of sale (POS) data, e-wallet data, payroll data, banking data, and/or mail service data. In some cases, restructuring the accessed data from the different data sources into the unified format may include standardizing the data according to which category of software application the data was received from.

In some examples, restructuring the accessed data from the different data sources into the unified format may include analyzing a class, type, or subtype of each account from multiple different accounts and recoding the data into universal reference values. In some embodiments, restructuring the accessed data from the different data sources into the unified format further may include storing the restructured data in a universal, denormalized data structure. In some cases, the stored restructured data may be categorized by application category in a columnar database.

In some embodiments, a system may be provided. The system may include at least one physical processor, and physical memory comprising computer-executable instructions that, when executed by the physical processor, cause the physical processor to: access data from multiple different data sources, where each data source is associated with a common objective, restructure the accessed data from the different data sources into a unified format, identify dependencies between the accessed data from the different data sources, analyze the accessed data and the identified dependencies to determine at least one operational step that is to be taken to further the common objective, and implement the determined operational step.

In some cases, the step of analyzing the accessed data and the identified dependencies to determine at least one operational step that is to be taken may include accessing one or more specified rules that are to be implemented in the analysis. In some examples, the rules may specify which of the accessed data is the most relevant for a specific entity.

In some embodiments, the step of analyzing the accessed data and the identified dependencies to determine at least one operational step that is to be taken is performed using machine learning. In some cases, the machine learning may implement one or more machine learning algorithms to learn which data and dependencies are to be used to determine the at least one operational step. In some cases, the machine learning algorithms may implement a feedback loop when learning which data and dependencies are to be used to determine at least one operational step.

In some cases, a non-transitory computer-readable medium may be provided. The non-transitory computer-readable medium may include one or more computer-executable instructions that, when executed by at least one processor of a computing device, cause the computing device to: access data from multiple different data sources, where each data source is associated with a common objective, restructure the accessed data from the different data sources into a unified format, identify dependencies between the accessed data from the different data sources, analyze the accessed data and the identified dependencies to determine at least one operational step that is to be taken to further the common objective, and implement the determined operational step.

In some cases, the processor may further generate a notification indicating various effects of the determined operational step. In some examples, the notification may be generated based on data from the different data sources. In some embodiments, the processor may further validate the relevancy of the determined operational step according to one or more usefulness factors. In some cases, the processor may also mix data from the different data sources, prior to restructuring the data sources. In such cases, the mixing may include accessing data from different categories of software applications and combining that data for determining the operational step.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIG. 1 illustrates a computing environment in which the embodiments described herein may operate.

FIG. 2 is a flow diagram of an exemplary method for providing actionable, operational steps to entities based on a variety of data sources.

FIG. 3 illustrates an embodiment in which an identified operational step may be carried out in multiple ways.

FIG. 4 illustrates an embodiment of a machine learning (ML) module that includes a plurality of different ML components.

FIG. 5 illustrates an embodiment of one or more different types of data that may be accessed and restructured to identify an actionable operational step.

FIG. 6 illustrates a workflow of an exemplary method for providing actionable, operational steps to entities based on a variety of data sources.

FIG. 7 illustrates a workflow of a data updating process as used to provide actionable operational steps.

FIG. 8 illustrates a flow diagram in which various entities perform roles in securely transferring data.

FIG. 9 illustrates a workflow in which cross-channel monitoring is implemented to provide actionable, operational steps.

FIG. 10 illustrates a workflow in which cross-channel actionable insights are generated.

Throughout the drawings, identical reference characters and descriptions indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

The present disclosure provides a cross-channel actionable insights generation system based on the analysis of multiple data sources. This insights generation system may implement multiple different data sources and different combinations of data sources. Prior systems, on the other hand, were very limited in the number of data sources implemented, or were aimed at solving narrowly focused problems. Such business areas as logistics, banking transactions, e-commerce, point of sale (POS), payroll, and others are typically not considered by traditional systems in operational analysis and insights generation.

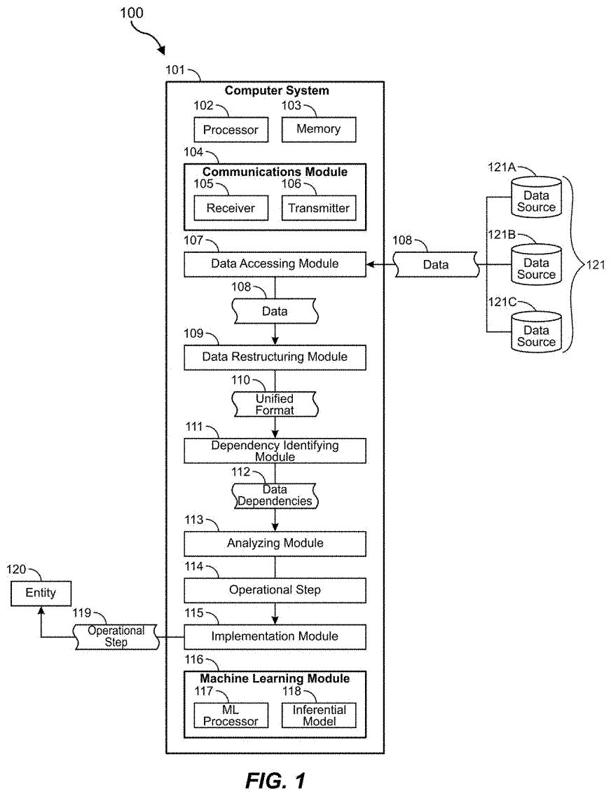

The embodiments described herein, in contrast, may take into account multiple different factors from multiple areas of an entity's operations. These embodiments may then generate relevant, cross-channel actionable insights for the entities including individuals, businesses, governments, or other organizations. These cross-channel actionable insights (also referred to as “insights” or “operational steps” herein) may include physical actions performed on physical processes, some of which may be automatically carried out by machines or physical equipment. Other operational steps may include software-based processes that may be carried out via software applications. In some cases, machine learning models may be trained to identify these operational steps. Still further, in at least some embodiments, machine learning models may be trained to determine which operational steps to carry out and then initiate those steps. Moreover, at least in some cases, machine learning models may be trained to predict potential outcomes related to the implementation of different operational steps, and provide those predictions to decision-making entities. Each of these embodiments will be described in greater detail below with regard to FIGS. 1-10.

Features from any of the embodiments described herein may be used in combination with one another in accordance with the general principles described herein. These and other embodiments, features, and advantages will be more fully understood upon reading the following detailed description in conjunction with the accompanying drawings and claims.

FIG. 1 illustrates a computing environment 100 that includes a computer system 101. The computer system 101 may include software modules, embedded hardware components such as processors, or includes a combination of hardware and software. The computer system 101 may include substantially any type of computing system including a local computing system or a distributed (e.g., cloud) computing system. In some cases, the computer system 101 may include at least one processor 102 and at least some system memory 103. The computer system 101 may include program modules for performing a variety of different functions. The program modules may be hardware-based, software-based, or may include a combination of hardware and software. Each program module may use computing hardware and/or software to perform specified functions, including those described herein below.

The computer system 101 may include a communications module 104 that is configured to communicate with other computer systems. The communications module 104 may include any wired or wireless communication means that can receive and/or transmit data to or from other computer systems. These communication means may include hardware interfaces including Ethernet adapters, WIFI adapters, hardware radios including, for example, a hardware-based receiver 105, a hardware-based transmitter 106, or a combined hardware-based transceiver capable of both receiving and transmitting data. The radios may be cellular radios, Bluetooth radios, global positioning system (GPS) radios, or other types of radios. The communications module 104 may be configured to interact with databases, mobile computing devices (such as mobile phones or tablets), embedded or other types of computing systems.

The computer system 101 may also include a data accessing module 107. The data accessing module 107 may access various types of data from different data sources 121. For instance, in some cases, data accessing module 107 may access data 108 from data source 121A. The data source 121A may include data related to accounting or client relationship management (CRM) associated with an entity 120. Additionally or alternatively, the data accessing module 107 may access data 108 from data source 121B, which may include e-commerce data, web analytics data, logistics data, and/or POS data associated with an entity 120. Still further, the data accessing module 107 may access data 108 from data source 121C (or some other data source), which may include e-wallet data, payroll data, banking data, mail service data, social media data, or some other type of data associated with an entity 120. Each of these data stores may gather information from various ongoing operations. As such, the data may be live, up-to-the second data. In other cases, the data may be stored, historical data related to any of the above data categories.

Upon accessing this data 108, the data restructuring module 109 may restructure the different types of data into a common, unified data format. As will be understood, the various data sources 121 may collect, organize, and store data in different manners. In some cases, the computer system 101 may mix data from the various data sources 121, prior to restructuring the data sources. The mixing may include accessing data from different categories of software applications and combining that data for determining the operational step. Some types of data may not mesh with other data types. Moreover, some of the data 108 may be stored in different formats that lack a common accessibility. Accordingly, the data restructuring module 109 may restructure some or all of the data 108 into a unified format 110 upon which operational steps may be determined. In at least some cases, the data 108 may be restructured into a unified format 110 that is understandable to a machine learning model and that is usable to train the machine learning model.

The dependency identifying module 111 may be configured to identify dependencies 112 between different types of data. For instance, payroll data may depend on banking data. These dependencies may affect how the data is analyzed, which may, in turn, affect which operational steps are identified. Accordingly, the dependency identifying module 111 may be configured to parse the different types of data 108 that have been restructured into the unified format 110, and may determine which data depends from other data sources. These dependencies may then be accounted for when analyzing the data to identify actionable, operational steps.

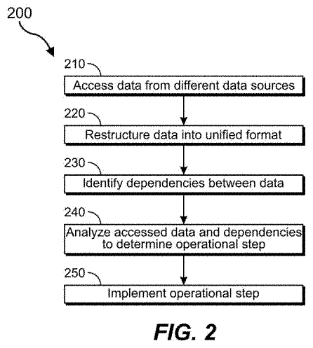

Once the data dependencies 112 have been identified, the analyzing module 113 of computer system 101 may analyze the data 108 and associated dependencies 112 to identify operational steps 114 that may be taken to improve operational outcomes of the entity 120. This process of analyzing the data 108 and associated dependencies 112 to identify operational steps 114 will be described further below. Upon identifying one or more operational steps 114, the implementation module 115 may provide the identified operational step to the entity 120 or may carry out all or portions of the identified operational step 114 automatically. In some cases, a machine learning module 116, including a machine learning processor 117 and/or an inferential model 118, may be implemented to perform the data dependency identification and/or to identify the actionable, operational steps 114. In such cases, a machine learning model may be trained using data 108 and feedback systems that allow the ML model to better identify dependencies and identify more relevant operational steps over time. The above concepts will be described further below with regard to method 200 of FIG. 2.

FIG. 2 is a flow diagram of an exemplary computer-implemented method 200 for providing actionable, operational steps to entities based on a variety of data sources. The steps shown in FIG. 2 may be performed by any suitable computer-executable code and/or computing system, including the system illustrated in FIG. 1. In one example, each of the steps shown in FIG. 2 may represent an algorithm whose structure includes and/or is represented by multiple sub-steps, examples of which will be provided in greater detail below.

As illustrated in FIG. 2, at step 210, one or more of the systems described herein may access data from a plurality of different data sources. Each of these data sources may be associated with a common objective. Thus, for example, the data accessing module 107 of FIG. 1 may access data 108 from one or more different data sources 121. These data sources may include web analytics data, social media data, payroll data, and other types of data. Each of these types of data may represent different aspects of operations that are performed by an entity (e.g., 120). Each of these types of data may include indications of areas where improvements may be made to certain operational steps.

Detecting and extracting these indications of improvement, however, and identifying concrete, actionable steps to implement those indications of improvement, may be difficult. Indeed, in some cases, identifying these operational steps may not be possible for humans. The embodiments herein may be designed to identify trends, data dependencies, outlier scenarios, new streams of data, or other indicators that would not be identifiable to a human user. Moreover, at least in some cases, the data 108 being accessed and analyzed may include many hundreds, thousands, or millions of gigabytes per second (or higher). The systems herein may perform these analyses dynamically, on-the-fly, as the data is received. In such scenarios, it is simply infeasible for these operational steps to be identified outside of the systems described herein.

Method 200 of FIG. 2 next includes a step of restructuring the accessed data from the plurality of different data sources into a unified format (220). The data restructuring module 109 of FIG. 1 may restructure the accessed data 108 into a unified format 110. As noted above, each of the various data types accessed from the different data sources 121A-121C may be structured or formatted differently. Some data may include amounts of currency, some data may include warehouse information, some data may include a number of customers or sales, some data may include web analytics, customer acquisition channels, or other data. Each of these different types of data may represent different operational aspects of an entity. The restructuring module 109 may access each of the various types of data and restructure that data into a unified format 110 that allows the different types of data to be analyzed side-by-side in a coherent and functional manner. Achieving the unified format may include removing data, adding data, recategorizing data, moving data to different locations, or performing other operations on the data. This restructuring may preserve the underlying dependencies between the data types so that they are later discoverable, while transforming the data from a conglomeration of different data formats to a single, unified data format. The resulting unified data format 110 may allow the data 108 to be analyzed for dependencies in step 230 of method 200.

Indeed, step 230 of method 200 includes identifying one or more dependencies between the accessed data from the plurality of different data sources. The dependency identifying module 111 may analyze the data 108 from the various sources 121 to identify dependencies between the data. In some cases, ratings data or number of subscribers may depend on or be linked to a number of visits or a number of paid customers. Similarly, trade credit available to an entity may depend on expenses, income, or deposits. Other types of data including e-commerce data may be tied to CRM data or other types of data. In some cases, a type of data may be dependent on multiple different types of data. As such, the dependency identifying module 111 may be configured to determine that two data types are associated and, at least in some cases, are dependent on one another. These data dependencies 112 may be accounted for when identifying actionable insights or specific operational steps that may be taken to improve various aspects of an entity's operations.

At step 240 of method 200, the systems herein may analyze the accessed data 108 and the identified dependencies 112 to determine at least one operational step 114 that is to be taken to further the common objective and, at step 250, the systems herein may implement the determined operational step 114. Accordingly, the analyzing module 113 of computer system 101, either alone or in conjunction with the machine learning module 116, may analyze the accessed data 108 and the identified dependencies 112 to identify at least one operational step 114 that may be carried out to accomplish a common objective that improves the position or the operations of the entity. The implementation module 115 may then carry out that operational step 114.

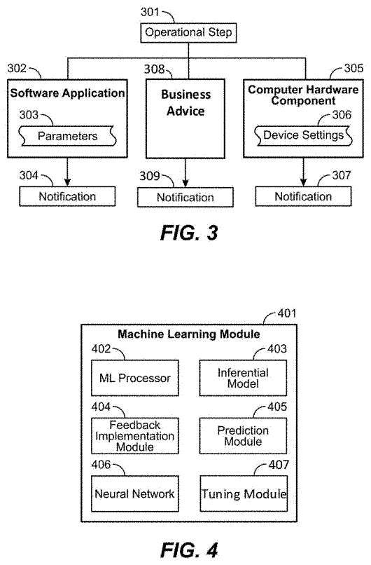

In some cases, the determined operational step may include changing various operational parameters on a software application. For example, as shown in FIG. 3, operational step 301 may include changing one or more parameters 303 associated with a software application 302. The software application may control an aspect of accounting, CRM, e-commerce, web analytics, payroll, banking data, or other similar data. In some cases, the operational step 301 may be carried out automatically. Thus, if the systems herein determine that a software application may operate more efficiently, or that changing various parameter 303 associated with the software application 302 may cause the application to operate more efficiently, or may cause additional work to be done that advances the operations of the entity, the operational step(s) 114 that would cause those changes may be carried out automatically. For instance, in some cases, the operational step may recommend who should be hired or fired within an entity, which measures can be taken to increase revenue, which items could be removed to cut costs, how invoices can be paid in a more timely manner, how receivables can be collected in a more timely manner, or other insights that may be used to make the operations of the entity more efficient. In some cases, the machine learning module 116 of FIG. 1 may be implemented to predict a future outcome of the automatically applied software parameter changes. This prediction may be provided to the entity 120 as a notification 304.

Additionally or alternatively, the determined operational step 114 may include changing one or more operational parameters of a computer hardware component. For instance, the operational step 301 may include changing device settings 306 or configuration settings for a computer hardware component. In some cases, the operational step may include directly controlling a computer hardware component including a processor, memory, data storage, a network adapter, a controller, a display, or other piece of computer hardware. In other cases, the operational step 301 may include changing device settings 306 or configuration settings for a piece of machinery or heavy equipment (e.g., warehouse equipment, industrial machines, robots, etc.). Although the hardware component may be computer-related, at least in some embodiments, the hardware component may be a physical machine that may be controlled to perform operations for the entity in a more efficient manner (e.g., guiding warehouse robots to a location in a more direct or safer route) or to perform different (potentially new) operations to increase the position or operational output of the entity. As with the changes to the software application 302, the changes to the (computer) hardware component 305 may be applied automatically, and may be dynamically updated over time as new data is accessed and analyzed (e.g., on a periodic basis such as every minute or every hour, etc.). In some cases, the entity may be notified of these changes via notification 307 or, if desired, the entity may opt to omit such notifications. Still further, at least in some cases, the operational step 301 may include at least some portion of business advice 308. This business advice 308 may include substantially any type of information that may assist a business entity in achieving a specified business objective. The business advice 308, like the changes to the software applications or computer hardware components may be communicated to entities using notifications 309, which may be part of or different from notifications 304 and 307.

At least some of the embodiments described herein may train and/or implement a machine learning model. For example, FIG. 4 illustrates a machine learning module 401 that includes various ML-related components. These components may include a machine learning (ML) processor 402, an inferential model 403, a feedback implementation module 404, a prediction module 405, and/or a neural network 406. Each of these components may be configured to perform different functions with respect to training and/or implementing a machine learning model. The ML processor 402, for example, may be a dedicated, special-purpose processor with logic and circuitry designed to perform machine learning. The ML processor 402 may work in tandem with the feedback implementation module 404 to access data and use feedback to train an ML model. For instance, the ML processor 402 may access one or more different training data sets. The ML processor 402 and/or the feedback implementation module 404 may use these training data sets to iterate through positive and negative samples and improve the ML model over time.

In some cases, the machine learning module 401 may include an inferential model 403. As used herein, the term “inferential model” may refer to purely statistical models, purely machine learning models, or any combination of statistical and machine learning models. Such inferential models may include neural networks 406 such as recurrent neural networks. In some embodiments, the recurrent neural network may be a long short-term memory (LSTM) neural network. Such recurrent neural networks are not limited to LSTM neural networks, and may have any other suitable architecture. For example, in some embodiments, the neural network 406 may be a fully recurrent neural network, a gated recurrent neural network, a recursive neural network, a Hopfield neural network, an associative memory neural network, an Elman neural network, a Jordan neural network, an echo state neural network, a second order recurrent neural network, and/or any other suitable type of recurrent neural network. In other embodiments, neural networks that are not recurrent neural networks may be used. For example, deep neural networks, convolutional neural networks, and/or feedforward neural networks, may be used. In some implementations, the inferential model 403 may be an unsupervised machine learning model, e.g., where previous data (on which the inferential model was previously trained) is not required.

At least some of the embodiments described herein may include training a neural network to identify data dependencies, identify operational steps, predict potential outcomes of the operational steps, or perform other functions. In some embodiments, the systems described herein may include a neural network that is trained to identify operational steps using different types of data and associated data dependencies. For example, the embodiments herein may use a feed-forward neural network. In some embodiments, some or all of the neural network training may happen offline. Additionally or alternatively, some of the training may happen online. In some examples, offline development may include feature and model development, training, and/or test and evaluation.

In one embodiment, a repository that includes data about past data accessed and past operational steps identified may supply the training and/or testing data. In one example, when the underlying system had accessed different types of data from different data sources, the system may determine which operational steps to identify based on data from a feature repository and/or an online recommendation model that may be informed by the results of offline development. In one embodiment, the output of the machine learning model may include a collection of vectors of floats, where each vector represents a data source and each float within the vector represents the probability that a specified operational step will be identified. In some embodiments, the recent history of a data source may be weighted higher than older history data. For example, if a data source had repeatedly provided relevant data the resulted in relevant operational steps, the ML model may determine that the probability of that data source providing relevant data in the future is higher than for other data sources.

Once the machine learning model has been trained, the ML model may be used to identify operational steps (e.g., 114 of FIG. 1) based on multiple different data sets. In some embodiments, the machine learning model that identifies these operational steps 114 may be hosted on various cloud-based distributed processors (e.g., ML processors 402) configured to perform the identification in real time or substantially in real time. Such cloud-based distributed processors may be dynamically added, in real time, to the process of identifying actionable, operational steps 114. These cloud-based distributed processors may work in tandem with the prediction module 405 of FIG. 4 to generate outcome predictions, according to the various data inputs (e.g., 121). These predictions may identify potential outcomes that would result from the identified operational steps 114 being carried out. The predictions output by the prediction module 405 may include associated probabilities of occurrence for each prediction. The prediction module 405 may be part of a trained machine learning model that may be implemented using the ML processor 402. In some embodiments, various components of the machine learning module 401 may test the accuracy of the trained machine learning model using, for example, proportion estimation. This proportion estimation may result in feedback that, in turn, may be used by the feedback implementation module 404 in a feedback loop to improve the ML model and train the model with greater accuracy.

The embodiments described herein may be designed to identify operational steps that are both relevant and specific. A single operational step may be a valuable change for one entity, but may be less helpful for other entities. As such, the systems herein may be designed to identify operational steps that are relevant to the entity. Moreover, the operational steps may be customized and tailored to a specific entity at the proper time to increase the chances that the operational step will be relevant. Still further, the operational step may be associated with a level of specificity. If the operational step provides general information or a step that is overly broad, that step may not be actionable and may, as a result, have lesser value to the entity.

In some embodiments, the ability to gather data from client companies or other entities may open the possibility of collectively studying, analyzing and predicting various key performance indicators (KPIs) of different entities. Having data from many different sources and from different companies may allow the embodiments herein to capture different aspects of similar companies or entities and identify the reasons for such differences. Moreover, information, surveys, studies from social media, and other data sources, in combination with the above-mentioned comparisons, may provide a thorough picture about the performance and possible improvements of an entity from the perspective of business growth or achieving another operational outcome.

At least in some cases, the embodiments described herein may generate and/or train separate ensembled supervised regression models (e.g., using ensemble learning) for each KPI. The trained ML models may be used for generating forecasts for the KPIs for future periods. After the forecasts are generated, the embodiments herein may generate insights based on the pairs or tuples of KPIs. In some cases, these KPIs may be defined by business logic. At least one advantage of such an approach is the ability to access data from different sources for distinct but similar entities. For example, if the systems herein observe growth of company A while similar company B does not have the same level of growth, the analytical systems described herein may detect the difference and suggest potential actions to company B. Those actions may be based on the comparison of metrics between the two companies, as well as comparisons to established success metrics taken from social media, surveys, or other sources for the same time period and for the same type of company from the same geographic region. In some cases, the embodiments herein may implement a schema to define this process.

The schema may include elements or components such as supervised regression models. Although, in some embodiments, for the establishment of similarities between entities, the systems herein may use unsupervised classification models as well. In some embodiments, predictions from different ML models may be combined by applying specific weights. Applying specific weights to different ML models may provide higher precision than just applying a single algorithm. As such, for the KPI predictions described above, the systems herein may generate ML algorithms in a variety of different manners according to needs and specific character of a given KPI (i.e., different ML algorithms and different weights may be implemented for each KPI prediction). For instance, the systems herein may implement support vector machines, seasonal and trend (STL) decomposition (e.g., using locally estimated scatterplot smoothing (LEOSS), which implements a statistical method of decomposing time series data into three components containing seasonality, trend, and residual data), vector autoregressions, which provides a univariate autoregressive model for forecasting a vector of time series data, and boosting algorithms including XGBOOST and CATBOOST.

The embodiments herein may include a single ensembled model for each KPI. The schema or flow may include various steps including data collection, data preparation, feature generation, and model training and prediction. Separately, the embodiments herein may aim to observe and study anomaly detection on input time series training data. This, on one hand, may serve as part of the normalisation process and, on the other hand, may be a good source for the study of new logically unexpected changes. Study of such changes and the processes which stimulate such unexpected changes are of high importance for generating valuable insights for entities.

Sector and sub-sector analyses may be implemented as a tool for understanding the various aspects and conditions under which the entity operates. Each industrial sector may be characterized with a certain set of metrics that are the best fit for a given industry. As such, estimating the right set of KPIs may make it possible for the entity to see the big picture, assess operational activities and overall performance, make realistic recommendations for future periods, and create actionable cross-insights.

In some cases, in order to create actionable cross-insights, two or more KPIs may be combined. These combinations may be based on: 1) mathematical formulas used for KPI calculation where, in these formulas, if either the counter or the denominator overlap, the underlying system may consider that selected set of KPIs are dependent and correlated to each other, 2) ML models where, while there may be no obvious relevance between the selected set of KPIs, the ML models may analyze the data to make the best estimations what kind of influence may occur if one of the KPI from the selected combination changes, or 3) a combination of 1 and 2.

For example, a KPI pair with two different KPIs may include a working capital ratio and an inventory turnover ratio. In one example, the working capital ratio may have a historical value of 1.5 over six months and a forecasted KPI value of 1.3 for the next six months. The inventory turnover ratio may have a historical value of 10% and a forecasted KPI value of 18%. One potential cross-channel actionable insight may indicate that the working capital ratio is, in this case, insignificant, but that the inventory turnover increase is a sign of having sufficient demand for the entity's goods or services, and that production of such should be increased.

At least one outcome of the process may include a recommendation for improvement of business performance. Each recommendation may be anticipated to be reasonable, relevant, clear, structured laconically, and professionally written. The recommendation may be a specific action or may be transferable into an action. Machine learning models may take into account other sources including social media, news, business reports, etc. Such broad industry based insights in combination with individual insights of a company may shed extra light on the performance and growth of the entity.

In some embodiments, the performance of the ML models described herein may be tuned (e.g., using tuning module 407). In some cases, this may be a manual check, a comparison, or even a correction of some predicted results. In some cases, such interaction may be provided by feedback from users or other entities. With every insight or actionable step, entities may have the ability to save it, alter it, like it, integrate it into a calendar, or otherwise dispose of it. In some cases, these actions may be transformed into labels for good, average, and bad for the generated insights. In some cases, these labels may be used in the prediction process for the period after the actions are performed. Over time, this may result in the increase of the performance of ML models used in KPI predictions and also for associated insight generating machines. In parallel to the user interaction, there may be a developer UI for insight interaction from entities which may analyse and study the impact of an insight on the entity's operations. In a similar way successful insights, insights of average impact, and low impact insights may be outlined and labelled accordingly for the further retrainement of the corresponding ML engine.

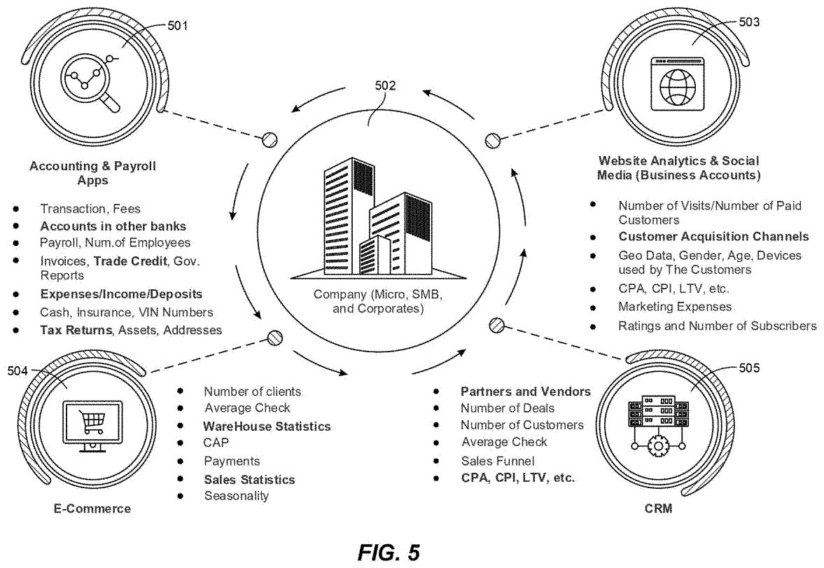

The embodiments described herein may access multiple different types of data to generate operational steps that are both specific and relevant to a chosen entity. For example, as shown in FIG. 5, the embodiments herein may access information generated by accounting and payroll software applications 501. These applications may provide information related to transactions, fees, accounts in other banks, the number of employees, invoices, trade credits, government reports, expenses, income, deposits, cash available, insurance information, tax returns, assets, and other types of information related to an entity 502. Still further, the systems herein may access website analytics and social media information 503 including, for example, the number of visits to a specific website provided by the entity 502, the number of paid customers, information regarding customer acquisition channels, geographic data, gender, age, electronic devices used by customers to access web or application data, cost per acquisition (CPA), cost performance index (CPI), long term value (LTV), marketing expenses, application or website ratings, number of subscribers, or other related information.

Still further, the systems herein may access e-commerce data 504 including, for example, the entity's number of clients, average check amount, warehouse statistics including robotics information, compliance assurance process (CAP) information, payment information, sales statistics, seasonality information, or other related information. Additionally or alternative, the systems herein may access client relations management (CRM) data 505 including, for example, who the entity's partners and vendors are, the number of deals made, the number of customers, average check size, sales funnel information, CPA, CPI, LTV, or other related information. It will be understood here that the various types of information illustrated in FIG. 5 may not be comprehensive, and that other types of information and other sources of information (e.g., 121 of FIG. 1) may be accessed and implemented when identifying actionable, operational steps. In at least some cases, having more data sources and having different types of data sources may provide increased relevance and specificity in the identified operational steps.

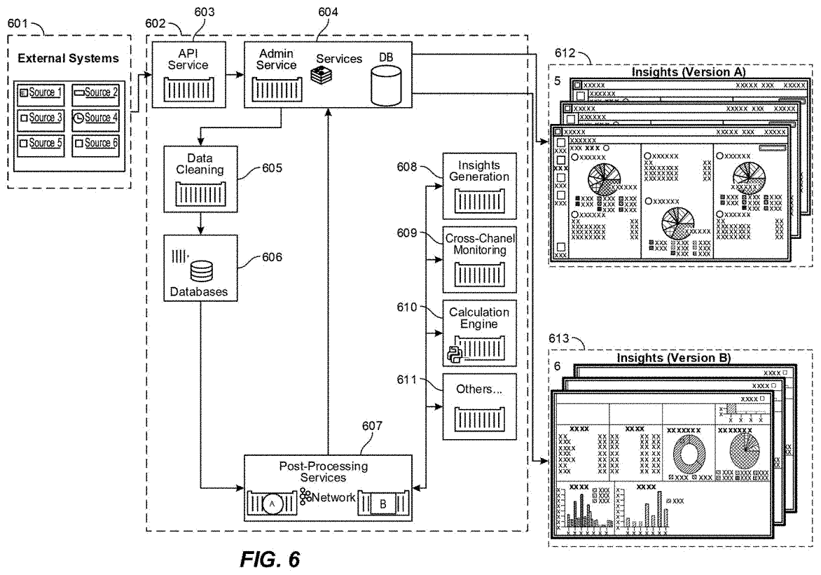

FIG. 6 illustrates an embodiment of a technical implementation, including various steps that may be taken to generate actionable, operational steps for an entity. The system 602 of FIG. 6 may receive data from a plurality of different external systems 601. These external systems may provide accounting information, website analytics and social media information, e-commerce information, (CRM) data (e.g., 501 and 503-505 of FIG. 5), or other types of data. The system 602 may determine which data sources need to be refreshed and the frequency at which they should be refreshed. The update period may be different for each type of information. Thus, some information may be updated every minute or every second, while other data types are updated every hour, every day, every week, etc. This updated data may be accessed using the application programming interface (API) service 603.

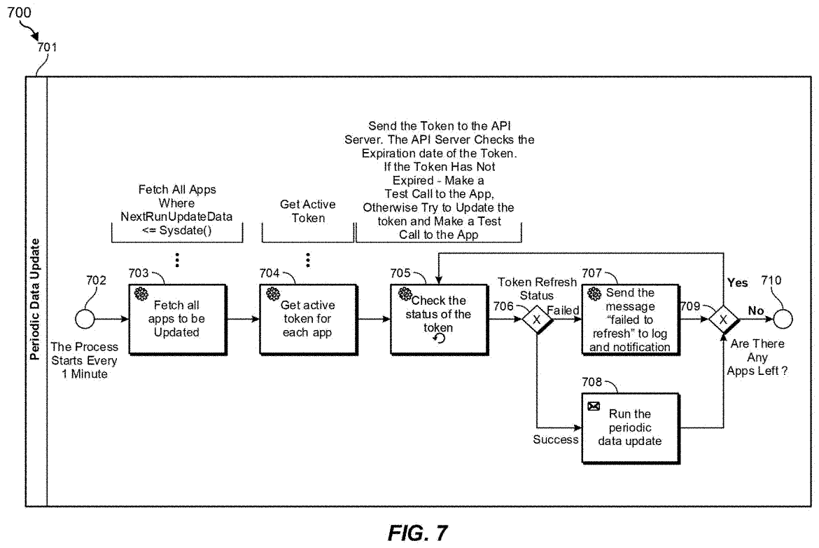

FIG. 7 illustrates an embodiment of a method flow for updating different data types. In method 700 of FIG. 7, a periodic data update 701 may start at point 702. This starting point may recur on a periodic basis (e.g., every one minute). The underlying system may fetch data from each of the applications or other data sources that are to be updated (703). At step 704, the underlying system may access an active token for each application (e.g., a web analytics application or an e-commerce application). At step 705, the underlying system may check the status of the token and, if the status check failed, at step 707 the system will send a “failed to refresh” message notification and log the failure. If the status check results in success, the system will run the periodic data update at step 708 and continue performing the updating process (at 709) until each of the data sources (e.g., each of the applications) has been updated (at 710).

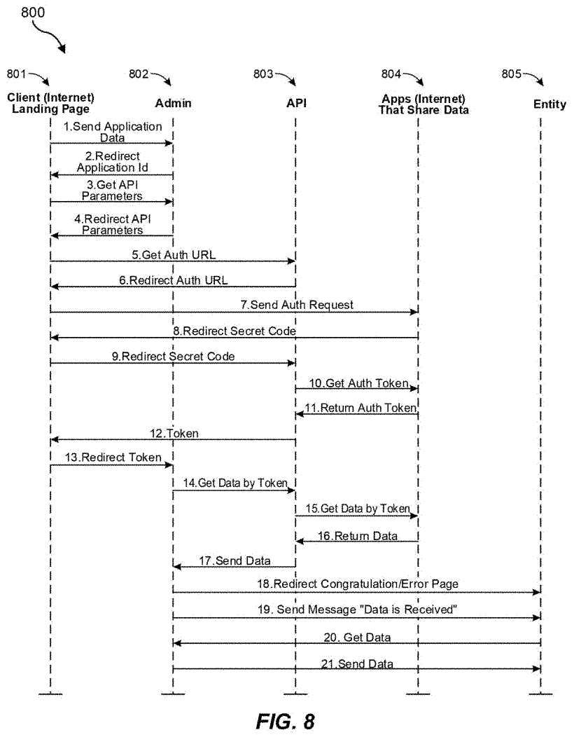

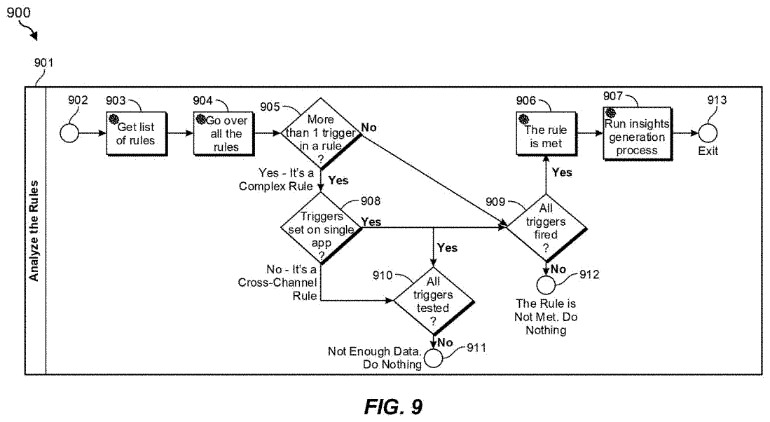

Within this rubric, the underlying system may issue various API calls to receive data from the different external systems 601. FIG. 8 provides more detail to step 705 of the periodic data updating process. In method 800 of FIG. 8, a client 801 may send application data to an administrative computer system 802 (step 1). The administrative computer system 802 may redirect the application identifier to the client (step 2). The client 801 may then request API parameters (step 3), and the administrative computer system 802 may redirect the requested API parameters to the client (step 4). The client 801 may then send a request for an authentication uniform resource locator (URL) to a backend API 803 (step 5). The backend API may then redirect the authentication URL to the client (step 6). The client 801 may then send an authentication request to one or more applications 804 that share data (step 7). The applications 804 may then provide a secret code to the client (step 8).

The client 801 may then redirect the secret code to the backend API 803 (step 9). The backend API 803 may then send a request for an authentication token to the applications 804 (step 10). The applications 804 may then return the requested authentication token to the backend API 803 (step 11). The backend API 803 may then send the authentication token to the client 801 (step 12). Upon receiving the authentication token, the client 801 may redirect the token to the administrative computer system 802 (step 13). The administrative computer system 802 may access data using the token through the API (step 14) and from the applications 804 (step 15). The applications 804 may return the requested data through the API 803 (step 16) to the administrative computer system 802 (step 17). The administrative computer system 802 may then redirect a congratulations or error page to an entity 805 (step 18) or send a “Data is received” message to the entity 805 (step 19). The entity 805 may then request data from the administrative computer system 802 (step 20), and the administrative computer system 802 may respond with the requested data (step 21). In this manner, the underlying system may use tokens (e.g., at 705) to safely and securely access information used in generating actionable, operational steps.

Returning to FIG. 6, this periodic updating process may thus involve the API service 603 and admin service 604, which may operate as generally shown in FIG. 8 to securely access data from different types of applications. At step 605 data may be automatically cleaned and structured in a unified format. In this cleaning and restructuring process, the data may be standardized according to application category. This categorization may save large amounts of computing resources including CPU cycles, memory, and data storage space during subsequent processing. The data from the various external systems 601 may be standardized according to app category (e.g., accounting, CRM, marketing, banks and banking data, e-commerce, public registries, e-wallets, point of sale (POS), logistics, analytics, enterprise resource planning (ERP), payroll, tax information, or other data sources 606). The post-processing services 605 may restructure the data to provide a common, unified format for the data. This unified format may include data such as statuses and entity types, entity names (documents, counterparties, payments, transactions, etc.), financial reports (balance sheet, profit and loss, etc.), management reports, dates, currencies, and other data types. At 606, the accessed data may be stored in a universal denormalized structure for storing standardized data, categorized by the app category (e.g., in a columnar database management system (DBMS)). In some cases, standardization of an entity's financial statements (e.g., balance sheet, profit and loss statement) from different systems and different countries into a single, unified format may be performed by analyzing the class, type, and/or subtype of each account from an account source and recoding the data into universal reference values.

The post-processing services of 607 may perform a variety of functions including generating cross-channel insights (e.g., operational steps 114) (608), performing cross-channel monitoring (609), calculating predictions regarding the identified operational steps (e.g., using calculation engine 610), and performing other operations (611). In some embodiments, the post-processing services 607 may be an analytical core that processes the data accessed from the various external systems 601. The post-processing services 607 may also calculate key business indicators, may compare the dynamics of various key business indicators, and may generate the operational steps used to advance the interests of a business or other entity.

In some embodiments, the post-processing services 607 may be performed in a specified sequence: after receiving a signal from the administrative service 604 that new data has been uploaded through the API 603, has been cleaned (605), and has been saved in a data store (606), the calculation engine 610 may calculate different key performance indicators (KPIs) based on the accessed data. Each KPI, having its associated business logic calculated by the calculation engine 610, may be compared with previous results, and subsequently sent back to the administrative service 604 to be saved in a database. In some cases, calculated KPI values may be retrieved along with additional data from various tables (e.g., universal tables), analyzed, and contextualized in further post-processing. In the step of cross-channel monitoring 609, the system may analyze various underlying rules and may test one or more data triggers using the KPI values calculated by the engine 610.

FIG. 9 describes a method flow 900 in which underlying rules are analyzed and data triggers are tested. In the method 900, the underlying system may analyze various rules (901) associated with a set of data. The system begins at point 902 and accesses a list of rules 903 to determine whether the rules contain triggers (at 904). If the system determines that a given rule has more than one trigger (at 905), the system has identified a complex rule and determines whether the triggers are set on a single application (at 908). If the triggers are set on a single application, and not all triggers are tested (at 910), the process ends at 911 without sufficient data. If triggers are set on a single application (at 908) and not all triggers are fired (at 909), the rule is not met, and the process ends (at 912). If there is not more than one trigger in a rule (at 905) and the rule is met (at 906), then the system will run the cross-channel insights generation process (at 907, also 608 of FIG. 6). The process will then exist at 913. In some embodiments, each trigger may be tested with its internal business logic, and may be tested using database (e.g., SQL) queries. In some cases, rules may be created by automatically generated by the underlying system based on machine learning protocols and/or trained machine learning models. Triggers for these rules may include the value or relevance to the entity, with higher value data items providing triggers to generate insights or operational steps based on that specific data.

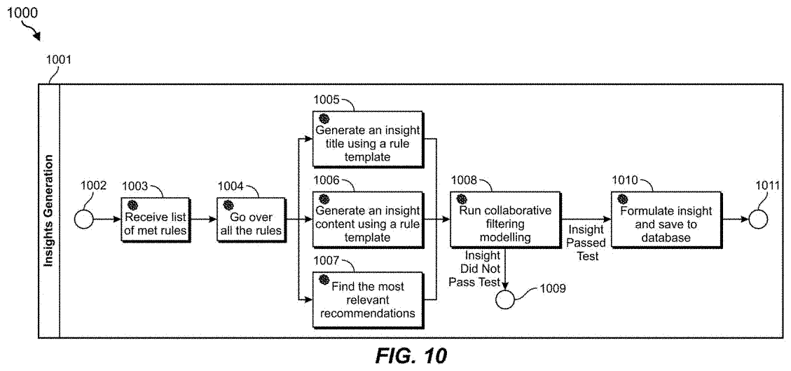

FIG. 10 provides a method flow 1000 for insights generation. In general, if a rule is met, then a cross-channel insight or operational step will be generated. These operational steps or insights may then be provided to software applications, to hardware devices, or to various entities. In some cases, different versions of insights may be provided including version A (612), version B (613), or other versions. In some cases, each version of insights may be intended for different entities including small businesses, managers, or other entities. The method 1000 of FIG. 10 may generate cross-channel insights 1001 by beginning at starting point 1002. At 1003, the underlying system may receive a list of rules that were met and, at 1004, may analyze those rules. Upon analyzing those rules, the system may generate an insight title using a rule template (1005), may generate insight content using a rule template (1006), or may find the most relevant recommendations (1007). The insight title may provide a high-level indication of what the insight is referring to. The insight content may include actual insights or operational steps that may be carried out, and those operational steps may be narrowed down by identifying which are the most relevant. Indeed, the underlying system may be configured to perform a validation of the relevance of each identified insight based on feedback on usefulness from other similar entities or based on how often the data is used or how high the data is ranked. In some cases, the insight title, content, and most relevant recommendations (at 1005, 1006, and 1007, respectively) may be generated automatically from a knowledge base acquired through the automatic parsing of business literature, news feeds, social networks, online and print media, scientific articles, and other data sources. The underlying system may then generate a subsequent markup of templates for appropriate business metrics and dependencies and use these templates to identify the most relevant operational step recommendations.

At step 1008, the method includes running a collaborative filtering process and, if the insight did not pass, the process ends at 1009, while if the process succeeds (e.g., the insight is sufficiently relevant), the insight will be saved to a database at 1010, and the process will end at 1011. In this collaborative filtering process, a first entity may apply a first operational step or series of steps to achieve specific results. Then, if a second entity wants to achieve similar results, the system may recommend similar operational steps to the second entity. In this manner, the underlying system may take into account a very large number of different data sources, and may further take into account many different factors from different areas of an entity's operations, and then generate highly relevant, actionable insights that, when taken, demonstrably improve the position or the concerns of the entity.

In some embodiments, as noted above, the various types of data accessed may be interlinked and, at least in some cases, dependent on each other. The systems herein may be configured to calculate common objective indicators based on the different types of data from the different data sources. These systems may then analyze the data dependencies when identifying the operational step that is to be taken and, as part of that analysis, may compare the calculated common objective indicators. These indicators may provide indications of which operational steps may be most relevant to an entity, or which operational steps may be most efficacious. The common objective indicators may identify information from the various data types that is most pertinent to the entity and will have the largest effect on the entity's operations. In some cases, the objective indicators may be identified using machine learning. Indeed, in some cases, a machine learning model may be trained in a multi-step process to identify objective indicators based on the plurality of different data types. The feedback implementation module 404 of FIG. 4 may then use feedback from the ML training steps to improve the ML model and enhance the ML model's ability to identify more relevant and more pertinent indicators. These indicators may then lead to more efficacious operational steps that may be carried out by or on behalf of the entity.

In some cases, the prediction module 405 of the ML module 401 may be configured to predict various potential outcomes of the identified operational steps. Indeed, each identified operational step (e.g., 114 of FIG. 1) may include many different outcomes. For instance, if the operational step involves changes to software application parameters, those changes may lead to certain defined outcomes. Still further, if the operational step involves changes to computer hardware, or changes to physical machines such as heavy equipment, robots, monitoring devices, sensors, mobile electronic devices, or other hardware devices used by the entity, the prediction module 405 may implement ML models, neural networks, inferential models, or other techniques to identify potential outcomes of these operational steps. Still further, the operational step may involve changes to decisions made by an entity including which individuals to hire or fire, how to handle invoices more efficiently, how and where to cut costs, or how to run operations more efficiently. The potential outcomes may be based on multiple different environmental factors, business factors, political factors, or other specified factors. Each of these factors may be used when predicting potential outcomes of the identified operational steps.

In some embodiments, when the system is analyzing data from the various data sources (e.g., 121 of FIG. 1) and taking into account the identified dependencies to determine an operational step that is to be taken, the system may further perform an analysis to ensure that the operational step 114 is actionable. In some cases, the underlying system may analyze the operational step to ensure that the step is timely, accurate, relevant to the entity, and is physically capable of being carried out. Accordingly, the analysis may take into account many different factors to ensure that the operational step 114 is something that is helpful to the entity, is relevant to the entity, and will substantially and demonstrably improve the entity's position.

In some cases, as noted above, the data accessed from the different data sources may be restructured into a unified format. In some cases, this restructuring process may include standardizing the data according to which category of software application the data was received from. Accordingly, as shown in FIG. 5, the data sources may include data from a wide range of different software applications. Each software application (or other data source) may be categorized into accountancy data (501), CRM data 505, e-commerce data 504, web analytics data 503, logistics data, point of sale (POS) data, e-wallet data, payroll data, banking data, mail service data, or other types of data. Each type of data may be grouped into a specific category based on business functionality, based on objectives, or based on other factors. In some cases, the data may be standardized based on which category of software application the data was received from. Still further, the data restructuring may include analyzing a class, type, or subtype of each account from multiple accounts and then recoding the data into universal reference values. The underlying system may analyze a data class or data type for the various data sources, and may then recode the data into universal reference values. These universal reference values may provide the unified format that can then be used to identify dependencies between the disparate types of data. This restructured data may then be stored in a universal, denormalized data structure (e.g., in a columnar database). As part of the data storage process, the restructured data may be categorized by application category within such a columnar database.

In some embodiments, once the restructured data has been implemented to identify one or more operational steps, the underlying system may generate a notification indicating various predicted effects of the determined operational step. The notification may be generated based on data from the various data sources, and may indicate the identified operational step(s) and/or the predicted outcome(s) of performing those operational steps. This notification may be sent to the entity 120 or to other individuals or entities. The entity 120 may then determine whether to implement the operational step or prevent the step from being performed. Alternatively, the operational step may be automatically implemented, and the notification may indicate that the step has been or will be performed automatically. In some cases, the underlying system may also validate the relevancy of the determined operational step(s) according to various usefulness factors. The relevancy may be informed by common objective indicators or key business indictors, as explained above. Still further, machine learning systems may be trained to identify and use the most relevant data sources to provide the most relevant and impactful operational steps.

In some embodiments, a corresponding system may be provided. The system may include at least one physical processor, and physical memory comprising computer-executable instructions that, when executed by the physical processor, cause the physical processor to: access data from a plurality of different data sources, each data source being associated with a common objective, restructure the accessed data from the plurality of different data sources into a unified format, identify one or more dependencies between the accessed data from the plurality of different data sources, analyze the accessed data and the identified dependencies to determine at least one operational step that is to be taken to further the common objective, and implement the determined operational step.

A non-transitory computer-readable medium may also be provided. The computer-readable medium may include one or more computer-executable instructions that, when executed by at least one processor of a computing device, cause the computing device to: access data from a plurality of different data sources, each data source being associated with a common objective, restructure the accessed data from the plurality of different data sources into a unified format, identify one or more dependencies between the accessed data from the plurality of different data sources, analyze the accessed data and the identified dependencies to determine at least one operational step that is to be taken to further the common objective, and implement the determined operational step.

In some example embodiments, a computer-executable method may be provided for using machine learning to predict an outcome associated with generation of actionable insights based on cross-analyses of data retrieved from different applications. The method may include: receiving training data including a plurality of records associated with features from different apps such as Accountancy, CRM, e-Commerce, Web-Analytics, Logistics, POS, e-Wallets, Payroll, Bank and mailing service. In some cases, the training data may include different data sets.

Additionally or alternatively, example embodiments may use a plurality of software-based, computer-executable machine learners to develop, from various data sets, at least one, consolidated data set that is used to set up computer-executable rules for prediction of data set outcomes. This method may additionally include processing of training data using the machine learning system, wherein the training data portion is anticipated to become reliable and in a computer-readable format. On the initial stage, the process includes: various data cleaning techniques including filling in or eliminating missing values, handling unknown values, identifying and handling outliers, handling categorical variables, etc. The method may further include techniques for filling in missing data, sampling and/or generating artificial data that are expected to be processed.

In some cases, the data processing described above may include data aggregation for development of computer-executable rules. The method may further include aggregation of historical data for various features such as annual turnover, volume of sales, number of employees, cash in and out flow, number of issued invoices, etc. The method may also include identification of proximity of data, wherein the combination of the data discloses predictable outcomes.

In other embodiments, the method may further include validating at least one set of rules using some or all of the training data. These rules may then be translated into cross-channel actionable insights dedicated for operational performance improvement. The method may further include obtaining at least one accurate predictive value and a sensitivity of at least one set of rules. In another embodiment, the method may include analyzing a news feed from different media conglomerates (BBC, Reuters, Bloomberg, etc.) and comparing social networks associated with at least one of the various entity's endeavors to at least one of the plurality of news items. This method may include monitoring a plurality of activities in a media and social network environment, detecting the data proximity and relevance to the particular entity, generating a plurality of news items for at least one activity and associated with at least one user, and displaying the news feed comprising at least one news item to at least one predetermined set of viewing users.

In another embodiment, the method may include analyzing weather conditions and determining how the weather conditions may affect an entity. For instance, the method may determine an entity's location and it's current and forecasted weather conditions. The method may then identify one or more operational steps based on the current and/or forecasted weather at the entity's location. Such an operational step may indicate, for example, that a large and potentially destructive storm is forecasted, and that a toy-based business entity, for example, may wish to halt advertisements online until the storm has passed and the wellbeing of the local population can be established. Still further, in another embodiment, the method may analyze data associated with seasonal and holiday cycles and how those cycles affect the specific business model of an entity. For instance, the method may analyze data related to a product or service provider's past sales leading up to a specific holiday, and may identify an optimal time to increase advertising spending or to increase sales calls.

Another example embodiment may include a system for using machine learning to predict an outcome associated with the operational performance. The system may include business performance data including a plurality of records associating feature variables with outcome variables, wherein each data set is associated with a respective outcome. The system may also include a processing module that is configured to identify the proximity of the businesses, applied rules for outcome generation, and respective cross-channel actionable insights. In some cases, the first outcome may be associated with the absolute values or the ranges of KPIs which are more or less than predetermined thresholds. Still further, in some embodiments, the thresholds may be determined by taking into account the time series data, but detecting the consistency of the initial data set, or by determining the parameter corresponding to the data set.

The system may further include memory for storing the parameter and control circuitry that is configured to receive the next data set corresponding to a defined first event following storage of the parameter. The system may be further configured to determine a threshold from the stored parameter in response to receiving the latter data set. The detection circuitry may include detection of defined latter events in response to the parameter subsequently crossing the determined threshold. In some cases, determining the threshold may include using a value of the parameter stored at a time prior to the receipt of the latter parameter value. Still further, in some cases, the feature variables may include, and are not limited to, financial or similar data.

In another embodiment, a computer system may be provided that uses machine learning to predict an outcome associated with the operational performance of an entity. The computer system may be configured to store training data including a plurality of records associating feature variables with outcome variables corresponding to at least one operational performance condition. The system may additionally be configured to consolidate each data set and derive weighted values for proxy feature variables. Still further, the system may be configured to detect anomalies in a time series data by retrieving the time series data, training the data (i.e., training a model) using simultaneously the set of models, and detecting the anomalies in the time series data set by the models for data series set monitoring purposes. Detection of anomaly may be based on differences between the forecasted and actual data points, wherein the anomaly is detected if the difference exceeds a predetermined threshold.

In some cases, the computer system may predict a set of insights for different entities via different user similarity measures while applying collaborative filtering and outputting the same recommendations for business performance improvement. In some cases, distinctions may be drawn between gestures (e.g. likes, dislikes etc.), actions (e.g. read, completed, done, put in digital calendar, etc.) and the entity performance improvement (considering the probability of the insights' positive influence). The computer system may also detect similarity measures among the users, and select the set of insights for a same user via different user similarity measures when applying collaborative filtering for the same user at different times, while choosing the set of insights for another user via the same user similarity measure.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive [data] to be transformed, transform the [data], output a result of the transformation to [perform a function], use the result of the transformation to [perform a function], and store the result of the transformation to [perform a function]. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

We claim:

1. A computer-implemented method comprising:
accessing data from a plurality of different data sources, each data source being associated with a common objective;
restructuring the accessed data from the plurality of different data sources into a unified format;
identifying one or more dependencies between the accessed data from the plurality of different data sources;
analyzing the accessed data and the identified dependencies to determine at least one operational step that is to be taken to further the common objective; and
implementing the determined operational step.

2. The computer-implemented method of claim 1, wherein the determined operational step includes changing one or more operational parameters on a software application.

3. The computer-implemented method of claim 1, wherein the determined operational step includes changing one or more operational parameters of a computer hardware component.

4. The computer-implemented method of claim 1, wherein the step of accessing data from the plurality of different data sources is automatically performed on a specified periodic basis.

5. The computer-implemented method of claim 1, further comprising:
calculating one or more common objective indicators based on the accessed data from the plurality of different sources; and
comparing the calculated common objective indicators when analyzing the identified dependencies to determine the at least one operational step that is to be taken.

6. The computer-implemented method of claim 1, further comprising predicting, based on one or more factors, at least one outcome of the determined operational step.

7. The computer-implemented method of claim 1, wherein analyzing the accessed data and the identified dependencies to determine at least one operational step that is to be taken includes performing an analysis to ensure that the operational step is actionable.

8. The computer-implemented method of claim 1, wherein the plurality of different data sources includes at least one of: accountancy data, client relationship management (CRM) data, eCommerce data, web analytics data, logistics data, point of sale (POS) data, e-wallet data, payroll data, banking data, or mail service data.

9. The computer-implemented method of claim 1, wherein restructuring the accessed data from the plurality of different data sources into the unified format includes standardizing the data according to which category of software application the data was received from.

10. The computer-implemented method of claim 1, wherein restructuring the accessed data from the plurality of different data sources into the unified format includes analyzing a class, type, or subtype of each account from a plurality of accounts and recoding the data into universal reference values.

11. The computer-implemented method of claim 1, wherein restructuring the accessed data from the plurality of different data sources into the unified format further includes storing the restructured data in a universal, denormalized data structure.

12. The computer-implemented method of claim 11, wherein the stored restructured data is categorized by application category in a columnar database.

13. A system comprising:
at least one physical processor; and
physical memory comprising computer-executable instructions that, when executed by the physical processor, cause the physical processor to:
access data from a plurality of different data sources, each data source being associated with a common objective;
restructure the accessed data from the plurality of different data sources into a unified format;
identify one or more dependencies between the accessed data from the plurality of different data sources;
analyze the accessed data and the identified dependencies to determine at least one operational step that is to be taken to further the common objective; and
implement the determined operational step.

14. The system of claim 13, wherein the step of analyzing the accessed data and the identified dependencies to determine at least one operational step that is to be taken includes accessing one or more specified rules that are to be implemented in the analysis.

15. The system of claim 14, wherein the rules specify which of the accessed data is the most relevant for a specific entity.

16. The system of claim 13, wherein the step of analyzing the accessed data and the identified dependencies to determine at least one operational step that is to be taken is performed using machine learning.

17. The system of claim 16, wherein the machine learning implements one or more machine learning algorithms to learn which data and dependencies are to be used to determine the at least one operational step.

18. The system of claim 16, wherein the machine learning algorithms implement a feedback loop when learning which data and dependencies are to be used to determine at least one operational step.

19. A non-transitory computer-readable medium comprising one or more computer-executable instructions that, when executed by at least one processor of a computing device, cause the computing device to:
access data from a plurality of different data sources, each data source being associated with a common objective;
restructure the accessed data from the plurality of different data sources into a unified format;
identify one or more dependencies between the accessed data from the plurality of different data sources;
analyze the accessed data and the identified dependencies to determine at least one operational step that is to be taken to further the common objective; and
implement the determined operational step.

20. The computer-readable medium of claim 19, further comprising generating a notification indicating one or more effects of the determined operational step, wherein the notification is generated based on data from the plurality of different data sources.
